(19) United States
(12) Patent Application Publication
(10) Pub. No.: US 2011/0146109 A1
(43) Pub. Date: Jun. 23, 2011

(54) SANDAL WITH MODULAR LIGHT UNIT

(76) Inventors: Lucas Martinez, Santa Barbara, CA (US); Angel Martinez, Santa Barbara, CA (US); Adam Druckman, Santa Barbara, CA (US); William Reimann, Boise, ID (US); Wei Huang, Guangdong (CN); Marc Alan Tappeiner, Santa Barbara, CA (US)

(21) Appl. No.: 12/644,834

(22) Filed: Dec. 22, 2009

(51) Int. Cl. A43B 23/00; F21V 21/08

(52) U.S. Cl. 36/137; 362/103

(57) ABSTRACT

An article of footwear comprising a sole and at least one strap connected to the sole, a mounting base permanently affixed to the strap and a modular light unit removably mounted to the base. The modular light unit contains a light, a power source and a switch between the power source and light operable to energize and denergize the light.

### BACKGROUND OF THE INVENTION

The present invention relates generally to footwear with a light, and more specifically, to a sandal with a strap and a removable modular light unit affixed to the strap.

Several models of footwear known in the art are supplied with lighting systems developed to illuminate the path of the wearer so that they can see or be seen in darkness. For example, in US 20060230641, a light is mounted onto the front of a shoe or sandal, and corresponding electrical circuitry and a power source for the light are stored in the sole of the footwear. One drawback to this lightening system is that it is difficult to replace the light when it becomes burned out or the power supply needs replaced. These lighting devices are also susceptible to unrepairable damage if the footwear is worn while participating in outdoor activities and the electrical components get wet or otherwise become permanently damaged. In this case, the only option for restoring lighting functionality may be to replace the entire shoe.

Other prior art devices, such as US 20020109981 and U.S. Pat. No. 3,067,322, resemble a flashlight that attaches to the outside of footwear using hooks or springs. While the lighting device can be removed when not in use, these devices are often bulky and lack aesthetic appeal because the footwear is not configured for receiving the unwieldy lighting device. These types of devices may also be susceptible to falling off of footwear because the footwear is not designed for supporting such a device.

### SUMMARY OF INVENTION

Embodiments of the present invention are directed to an article of footwear including a mounting base affixed to an upper and a modular light unit removably mounted to the base. As such, the light unit can easily be replaced when the light burns out or the wearer prefers a different style light unit or an unpowered ornament. All components required for operating the light, such as a battery and circuitry, are contained inside the light unit. Yet another feature is that since the footwear article is configured for receiving the light unit, it can remain on the mount when turned off and still be aesthetically appealing. Finally, a keychain is configured for receiving the modular light unit. The user can thereby alternatively mount the modular light unit on either the footwear, keychain, or both, as desired. When mounted on the footwear, the light unit illuminates the path of the wearer and allows the wearer to be seen in darkness. Alternatively, when the light unit is attached to a keychain, it can be used as a flashlight.

More specifically, one embodiment of the invention comprises an article of footwear including a sole and an upper connected to the sole, a mounting base permanently affixed to the upper and a modular light unit removably mounted to the base. The modular light unit contains a light, a power source and a switch between the power source and light operable to energize and denergize the light.

Another embodiment of the invention comprises a modular light assembly for an article of footwear and a keychain. The modular light unit has a light, a power source, a switch for energizing and deenergizing the light and a connector configured for removable mounting to a base. The footwear includes a first base and the keychain has a second base. The light unit is attachable and detachable from the first footwear base or the second keychain base, and can be easily moved from one base to the other as may be desired.

### BRIEF DESCRIPTION OF THE DRAWINGS

FIG. 1 is a front perspective view of the present sandal with a light;

FIG. 2 is a side elevation view of the sandal of FIG. 1;

FIG. 3 is a top view of the sandal of FIG. 1 with light unit attached;

FIG. 4 is a top view of the sandal of FIG. 1 with the light unit removed and showing the mounting base;

FIG. 5 is a top view of the mounting base;

FIG. 6 is a top perspective view of the modular light unit;

FIG. 7 is a bottom perspective view of the modular light unit;

FIG. 8 is an exploded view of the modular light unit;

FIG. 9 is a top perspective view of the modular light unit attached to a keychain;

FIG. 10 is a top perspective view of the keychain mounting base;

FIG. 11 is a top perspective view of the ornament; and

FIG. 12 is a bottom perspective view of ornament.

### DETAILED DESCRIPTION OF THE EMBODIMENT

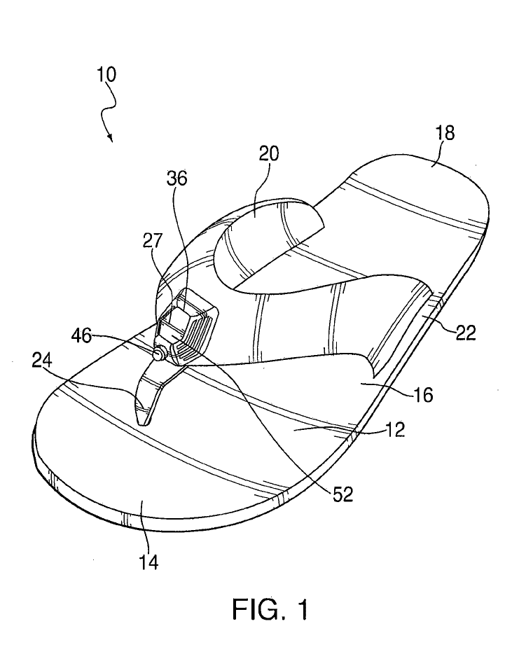

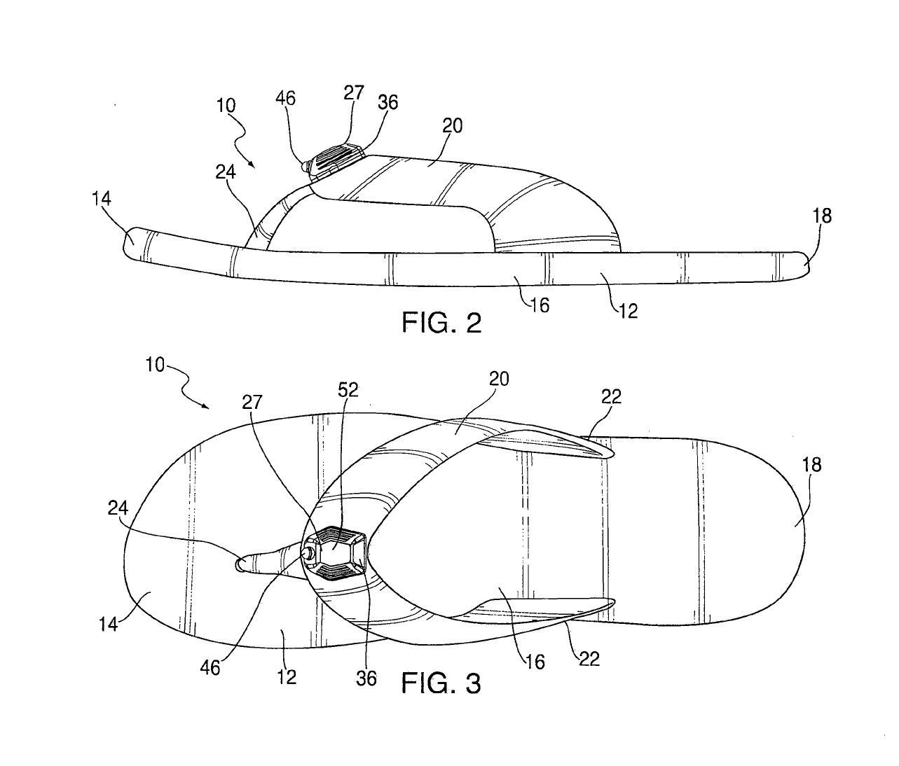

Referring now to FIGS. 1-3, an article of footwear, for example a sandal, is generally designated 10 and includes a sole 12. The sole 12 has a toe portion 14, middle portion 16 and heel portion 18, and is made out of materials known in the art that provide cushioning and comfort for a foot. Footwear 10 includes an upper, for example a strap 20 for maintaining the foot on the sole 12. The strap 20 is attached at its ends to the middle portion 16 of the sole, and preferably near an edge 22 of the sole middle portion. A toe post 24 is also provided and is attached to the sole toe portion 14 and strap 20. Preferably, the toe post 24 is affixed to a center portion of the strap 20.

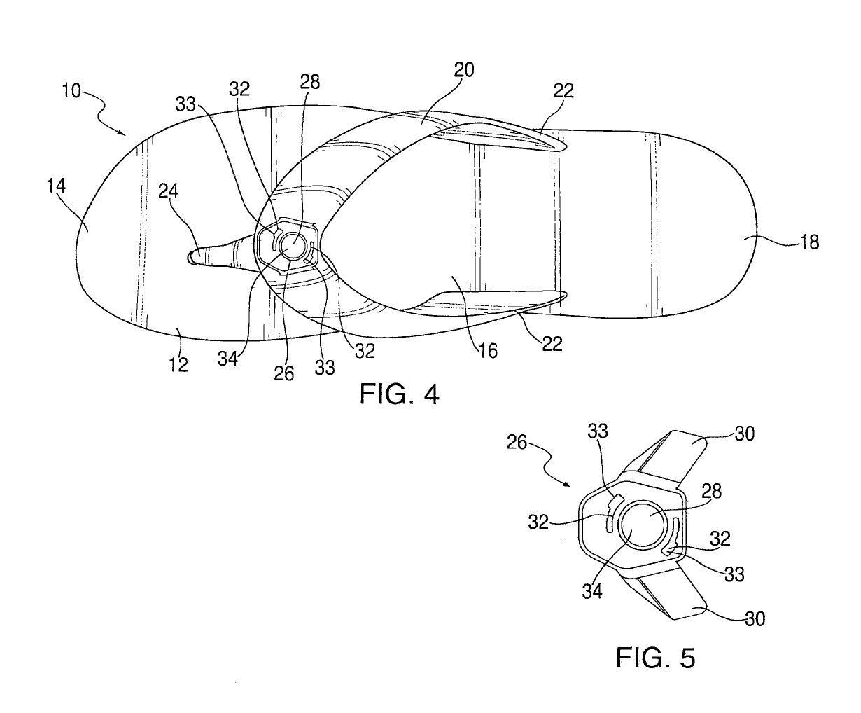

Moving now to FIGS. 4 and 5, a mounting base 26 is permanently affixed to the strap 20 for receiving a modular light unit 27. Preferably, the base 26 is permanently affixed to the center of the strap 20 by adhesive and/or sewing. The base 26 has a face 28 and two wings 30 depending from the face and for securing the base 26 to the strap 20. Materials such as plastic are preferred for the base 26. In this configuration, the base 26 is secured to the strap 20 by inserting each wing 30 into a slot inside the strap 20. The strap 20 includes an opening sized to allow access to the face 28 while the wings 30 remain mostly hidden inside the strap. Once the wings 30 are positioned inside the strap 20, the base 26 may also be sewn to the strap to provide an additional bond for securing the base to the strap. Other configurations for securing the mounting base 26 to the strap 20 may be used.

The mounting base 26 includes at least one and preferably two slots 32 for securing the light unit 27 to the strap 20. Preferably, the slot 32 is a bayonet slot as shown in FIGS. 4 and 5. The mounting base 26 may also include a circular aperture 34. Other techniques for removably attaching the light unit 27 to the base 26 may also be used.

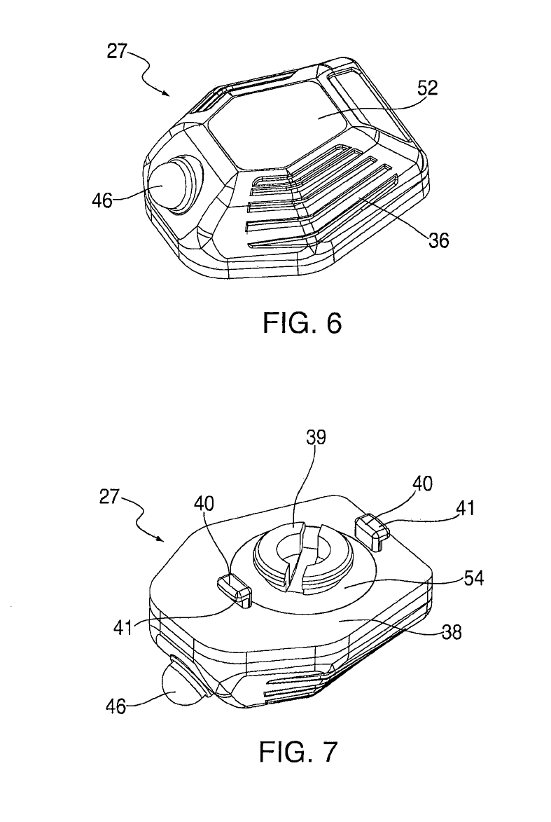

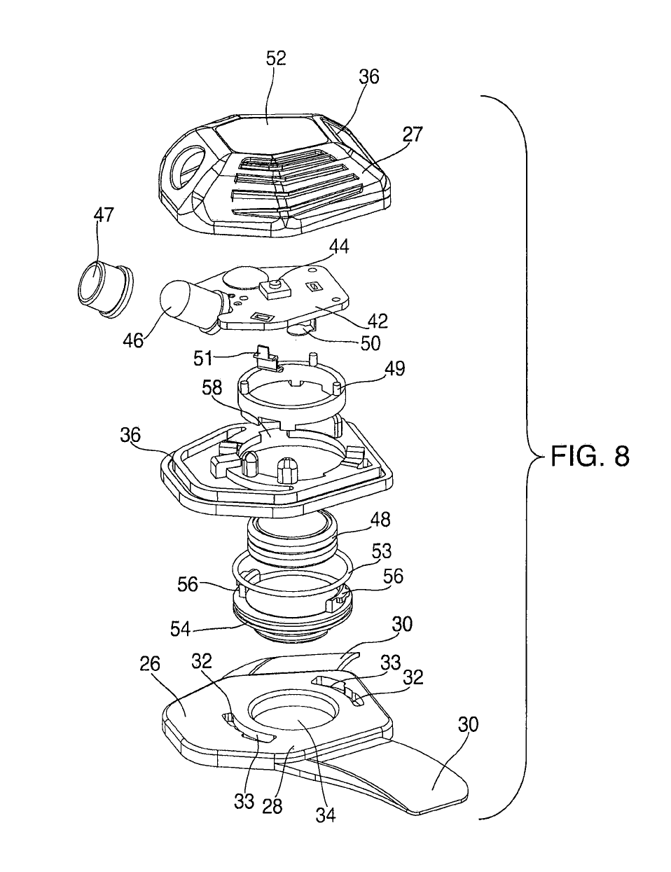

Referring now to FIGS. 3-7, the modular light unit 27 is removably mounted to the base 26 and includes a housing 36. A bottom side 38 of the hosing 36 has a pair of lugs 40 (shown in FIG. 7) configured to be received by the slot 32 and each lug has an enlarged head 41. The light unit 27 is attached to or removed from the base 26 by inserting the head 41 of the lugs 40 into an opening 33 rotating the unit and sliding the lugs 40 into slots 32. As such, slots 32 and corresponding lugs 40 securely fasten the light unit 27 to the strap 20 while allowing the light unit to be easily removed for replacement when damaged, burned out, or a different style unit is preferred. The bottom side 38 may also include a protuberance 39 sized to engage the aperture 34 and for providing an additional mechanism for securing the light unit 27 to the base 26. Like the aperture 34, the protuberance 39 is preferably round.

Since the sandal 10 includes the permanent mounting base 26 configured for receiving the light unit 27, the light unit can remain on the sandal 10 and be aesthetically appealing even when it is not in use. In this embodiment, the light unit 27 is in the general shape of a truncated pyramid, however, other shape configurations can be used.

Turing now to FIG. 8, the modular light unit 27 contains an electrical circuit board 42 with a switch 44 operable to energize and denergize a light 46. A power source 48 is also included for powering the light 46. Preferably, the power source 48 is a battery positioned in an included battery holder 49. More specifically, the preferred power source 48 is a pair of 3V lithium batteries. The batteries 48 provide power to the circuit board 42 and connected light 46 though a first connector 50 and second connector 51. This multi-connector 50, 51 configuration for use with 3V lithium batteries is commonly known in the art. In the preferred embodiment, the light 46 is a light emitting diode (LED) and may vary in color based on design choice. The light 46 may also be partially enclosed and held in place within a light cover 47. Other types of power sources 48 and lights 44 may be used based on preference. In this configuration, the light unit 27 includes a push button 52 associated with the switch 48 for energizing the light 46. The housing 36 further includes a gasket 53 for sealing the unit. As should be appreciated, all components required for operating the light 44 are contained inside the modular light unit 27.

The light unit housing 36 also includes a removable access cover 54 for accessing and replacing the power source 48. As such, the cover 54 is sized so that the power source or battery 48 can be inserted and removed. In this configuration and as shown in FIG. 8, the section 54 includes a pair of tabs 56 configured to engage a corresponding groove 58 in housing 36. The tabs 56 engage the groove 58 such that when the section 54 is rotated in a specified manner, it is either secured to the housing 36 or removed from the housing. Alternatively, cover 54 may be permanently sealed to the housing 36 so that the power supply 48 is not accessible.

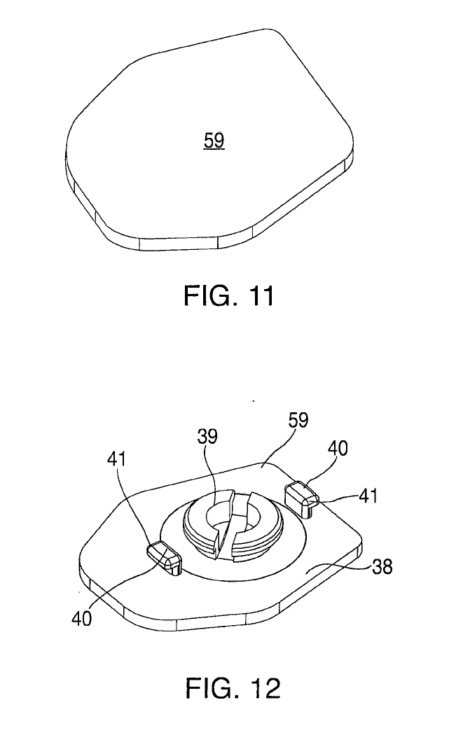

In some instances, it may be preferred to attach an unpowered modular ornament 59 (FIGS. 11 and 12) instead of a light unit 27 to the base 26. Similar to the light unit, ornament 59 includes lugs 40 configured to be received by the slots 32 on the sandal base 26. The ornament 59 may also include the protuberance 39. As with the light unit, ornaments 59 of different colors, materials or configurations may be easily attached/detached as desired.

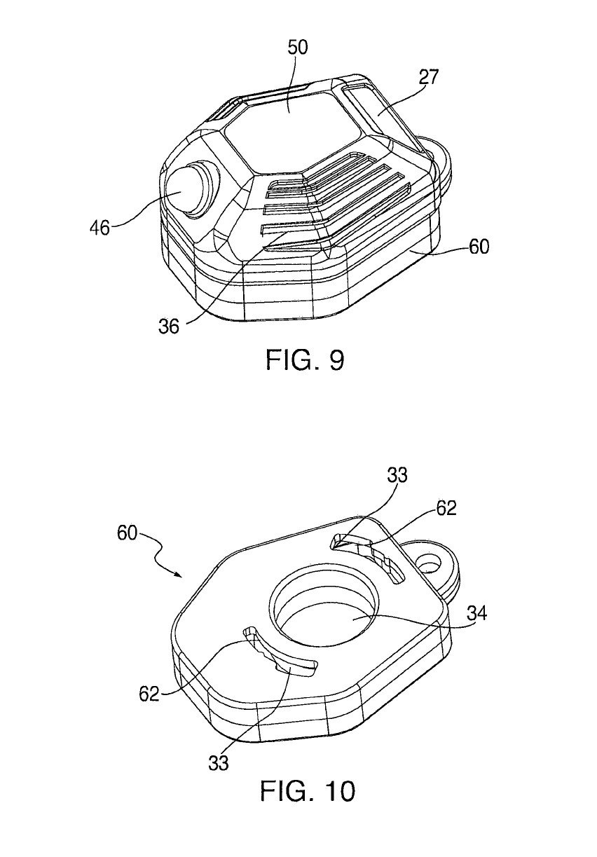

Moving now to FIGS. 9-10, the light unit 27 or ornament 59 can be alternatively attached to a keychain 60. Similar to the sandal base 26 described above, the keychain 60 includes a second base 62 having slots for receiving lugs 40. Slots 62 and corresponding lugs 40 securely fasten the light unit 27 or ornament 59 to the keychain 60 while an alternate light unit or ornament (if any) is used on the sandal 10. When the light unit 27 is attached to the keychain 60, can be used as a flashlight.

As should be appreciated, the modular system of the invention allows a customer to purchase a pair of sandals 10 with light modules 27 and/or ornaments that can be securely attached to one or the other or both the sandals and optional key chain 60. Since all components required to operate the light 46 are completely contained in the light unit 27, the unit can easily be moved from one sandal mounting base 26 to the second base 62 on key chain 60. Extra or replacement light units 27 or ornaments 59 of different colors and styles can be provided, and easily interchanged between the sandal 10 and keychain 60.

While a particular embodiment of the present sandal with modular light unit has been shown and described, it will be appreciated by those skilled in the art that changes and modifications may be made thereto without departing from the invention in its broader aspects and as set forth above.

What is claimed:

1. An article of footwear comprising:
a sole;
an upper connected to said sole;
a mounting base affixed to said upper; and
a modular light unit removably mounted to said base, said modular light unit containing a light, a power source, and a switch operable to energize and denergize said light.

2. The article of footwear of claim 1 wherein said switch comprises a push button for switching on said light unit.

3. The article of footwear of claim 1 wherein said light is a light emitting diode.

4. The article of footwear of claim 1 wherein said power source is a lithium battery.

5. The article of footwear of claim 1 wherein said modular light unit comprises a housing, one side of said housing having a pair of lugs, and said mounting base comprises a pair of bayonet slots configured to receive said lugs, said modular unit being attached to or removed from said base by sliding said lugs in said bayonet slots.

6. The article of footwear of claim 5 wherein said housing further comprises a removable cover for access to said power supply.

7. The article of footwear of claim 1 wherein said upper comprises at least one strap and a toe post connected to said sole and a strap, and wherein said mounting base is attached to said strap over said toe post.

8. An article of footwear comprising:
a sole having a toe portion, a middle portion and a heel portion;
a strap connected to the middle portion of said sole;
a toe post attached to the front portion of said sole, a middle portion of said strap being attached to said toe post;
a mounting base affixed to said strap over said toe post, said base having at least one bayonet slot; and
a modular light unit having at least one lug configured to engage said bayonet slot to removably mount said light unit to said mounting base, said light unit having a light, a power source and a button for energizing and denergizing said light.

9. A modular light unit assembly for attachment to a sandal or a key chain, comprising:
a first base carried by the sandal; and
a second base carried by the keychain; and
a modular light unit having a light, a power source and a switch for energizing and deenergizing said light, and a connector configured for removable connection to either said first base or said second base.

10. A modular assembly as in claim 9, further comprising an ornament having a connector for removable connection either to said first base or said second base.
